(19) United States
(12) Patent Application Publication
(10) Pub. No.: US 2026/0131234 A1
(43) Pub. Date: May 14, 2026

(54) MULTI SENSOR DYNAMIC ENCODING AND MACHINE LEARNING FOR COMPUTER GAME

(71) Applicant: Sony Interactive Entertainment Inc., Tokyo (JP)

(72) Inventors: Xiaoyong Ye, San Mateo, CA (US); Lakshmish Kaushik, San Mateo, CA (US)

(21) Appl. No.: 18/947,307

(22) Filed: Nov. 14, 2024

(51) Int. Cl. A63F 13/213

(52) U.S. Cl. CPC A63F 13/213

(57) ABSTRACT

MULTI SENSOR DYNAMIC ENCODING AND MACHINE LEARNING FOR

In one aspect, an apparatus includes at least one processor system configured to access image data, motion data, and audio data, and to provide the data to a machine learning (ML) model as input. The at least one processor system is also configured to receive, from the ML model in response to the input, an output indicating a player input to a computer game. The at least one processor system is further configured to, in response to receiving the output, provide the player input to the computer game.

### FIELD

The disclosure below relates to technically inventive, non-routine solutions that are necessarily rooted in computer technology and that produce concrete technical improvements. In particular, the disclosure below relates to a multi-sensor dynamic encoding and machine learning (ML) for computer games.

### BACKGROUND

As understood herein, processing various multi-modal user inputs to computer games through traditional methods can consume undue amounts of power, compute load, and bandwidth. There are currently no adequate solutions to the foregoing computer-related, technological problem.

### SUMMARY

Accordingly, in one aspect an apparatus includes at least one processor system configured to access image data, motion data, and audio data. The processor system is also configured to provide the image data, the motion data, and the audio data to a machine learning (ML) model as input. The at least one processor system is then configured to receive, from the ML model in response to the input, an output indicating a player input to a computer game. In response to receiving the output, the at least one processor system is configured to provide the player input to the computer game.

In some example implementations, the at least one processor system may also be configured to execute the computer game consistent with the player input.

In various example implementations, the image data may be received from a camera and may include video. The motion data may be received from an inertial measurement unit (IMU), which itself may include an accelerometer, a gyroscope, and/or a magnetometer. The audio data may be received from a microphone.

In addition, in some examples the ML model may include a latent vector model and/or a player-based encoder.

In another aspect, a method includes accessing image data, motion data, and audio data. The method also includes providing the image data, the motion data, and the audio data to a machine learning (ML) model as input. The method then includes receiving, from the ML model in response to the input, an output indicating a player input to a computer game. In response to receiving the output, the method includes providing the player input to the computer game.

In various examples, the method may also include executing the computer game consistent with the player input.

What's more, if desired the image data may be received from a camera, the motion data may be received from an inertial measurement unit (IMU), and/or the audio data may be received from a microphone.

Additionally, in some implementations, the ML model may include a latent vector model and/or a player-based encoder.

In still another aspect, an apparatus includes at least one computer readable storage medium (CRSM) that is not a transitory signal. The at least one CRSM includes instructions executable by a processor system to access image data, motion data, and audio data. The instructions are also executable to provide the image data, the motion data, and the audio data to a machine learning (ML) model as input. The instructions are then executable to receive, from the ML model in response to the input, an output indicating a player input to a computer game. The instructions are further executable to, in response to receiving the output, provide the player input to the computer game.

In some instances, the instructions may also be executable to execute the computer game consistent with the player input.

Also in various example instances, the image data may be received from a camera, the motion data may be received an accelerometer, a gyroscope, and/or a magnetometer, and the audio data may be received from a microphone. If desired, the ML model may include a latent vector model and a player-based encoder.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 shows example machine learning (ML) model architecture consistent with present principles;

FIG. 3 shows example logic in example flow chart format that may be executed by an apparatus consistent with present principles; and

FIG. 4 shows example logic in example flow chart format for training an ML model consistent with present principles.

### DETAILED DESCRIPTION

The detailed description below provides technical systems and methods for using multi-sensor dynamic encoding and machine learning to receive multimodal data (video/image/audio) from various sensor inputs (e.g., providing multiple GB/s of data) and to process the data while advantageously minimizing power consumption, compute load, and bandwidth, thus transferring/processing the data and generating outputs for dynamic game play. Accordingly, the ML model may be built to extract only player-useful information (e.g., a moving hand, eye focus, or dynamic scenes) for more effective learning to give useful output for games.

With the foregoing in mind, it is to be understood that this disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets and augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single-or multi-chip processor that can execute logic by means of various lines such as address lines, data lines, and control lines and registers and shift registers. A processor including a digital signal processor (DSP) may be an embodiment of circuitry. A processor system may include one or more processors acting independently or in concert with each other to execute an algorithm, whether those processors are in one device or more than one device.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

The term “a” or “an” in reference to an entity refers to one or more of that entity. As such, the terms “a” or “an”, “one or more”, and “at least one” can be used interchangeably herein.

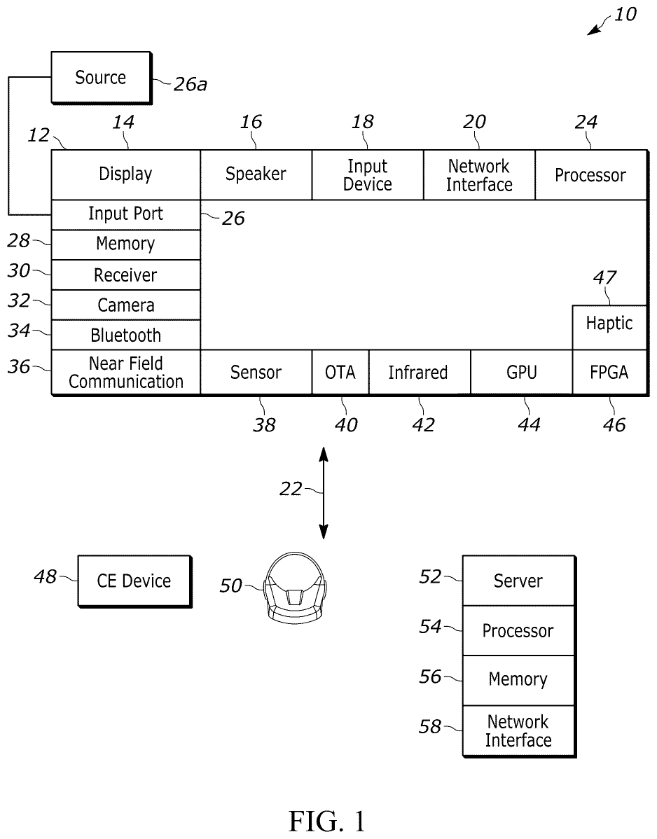

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12 consistent with present principles. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, global positioning system (GPS) receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer/video game audio and video to the AVD 12 via commands sent directly to the AVD 12 and/or through the below-described server, while a second CE device 50 may include similar components as the first CE device 48. The CE device 48 might additionally or alternatively be configured as a computer game controller manipulated by a player, or another CE device may be established as such.

Also in the example shown, the second CE device 50 may be a head-mounted display (HMD) worn by a player. The HMD may include a heads-up transparent or non-transparent display for respectively presenting AR content, mixed reality (MR) content, and/or virtual reality (VR) content (more generally, extended reality (XR) content). The HMD may be configured as a glasses-type display (e.g., smart glasses) or as a head-circumscribing AR or VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components discussed in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

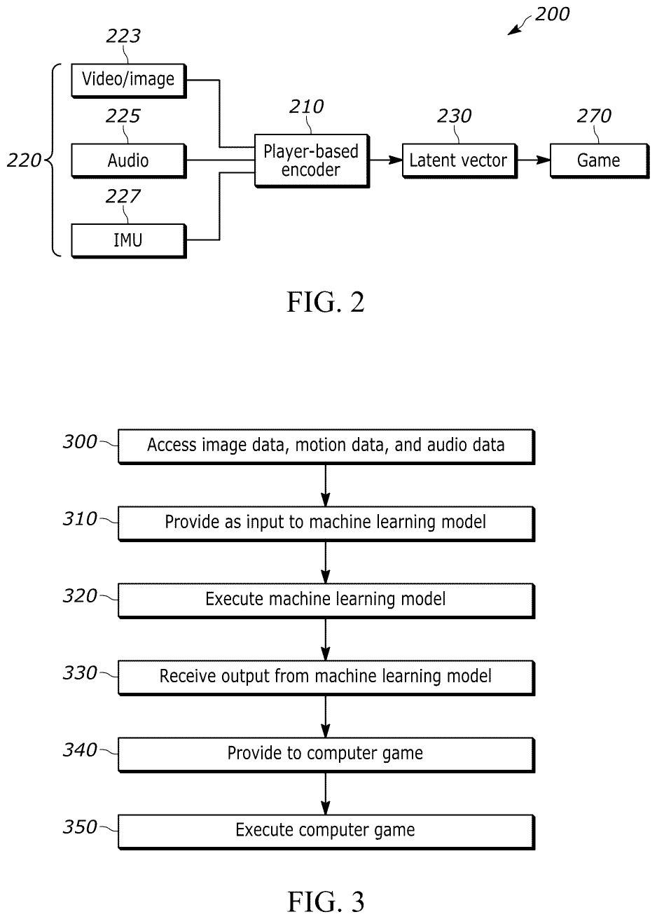

With the foregoing in mind, reference is now made to FIG. 2. This figure shows example artificial intelligence (AI) architecture for a machine learning (ML) model 200 that may be implemented consistent with present principles. The ML model 200 may therefore be used to filter sensor input down to a smaller amount of data that is player-specific and useful to the game engine of a computer game with minimal processing and power consumption.

Accordingly, the ML model 200 may include a player-based encoder 210. The player-based encoder 210 may be used to encode the various sensor inputs 220 into a predetermined format for subsequent processing by a latent vector model 230 that also forms part of the ML model 200. The latent vector model 230 may use latent space and embeddings to draw an inference as to an intended user input (game action) provided by the user visually, audibly, and through movement of an input device like a game controller. Thus, the latent vector model 230 may process images and video 223 provided by a camera in the user's local environment, process audio data 225 provided by a microphone in the local environment, and process inertial measurement unit (IMU) data 227 provided by an IMU on a headset or other device being worn or controlled by the user. An inference of a specific game input may then be output by the latent vector model 230 and provided as player input into a computer game/game engine 270.

The camera from which the data 223 is received may therefore be located on a headset being worn by the user or at another location within the user's environment, such as on the user's computer game controller. The images and video 223 may show eyes of the user, which may be useful by the game engine for eye tracking. The images and video 223 may also show free space gestures of the user as done with the user's body for the gesture intent to be provided to the game engine 270.

The microphone from which the audio data 225 is received may be located on the user's headset, computer game controller, or other device. The audio data 225 may therefore indicate voice commands or other voice input provided by the user as part of playing the computer game, with the translated command then being provided to the game engine 270.

The IMU from which the IMU data 227 is received may include one or more of an accelerometer, a gyroscope, and/or a magnetometer for sensing motion of the user. The IMU may be located on the headset, computer game controller, or elsewhere in the user's environment. The IMU data 227 may therefore indicate user gestures made using the associated device itself, with the translated command then being provided to the game engine 270.

Continuing the detailed description in reference to FIG. 3, this figure shows example logic that may be executed by an apparatus such as a client device (e.g., headset, smartphone, and/or game console) and/or coordinating server alone or in any appropriate combination consistent with present principles. Thus, in some examples the logic may be executed by a client device alone. In other examples, the logic may be executed by the remotely-located server alone. In still other examples, the logic may be executed by a client device and remotely-located server, where the client device performs some steps while the server performs other steps, and/or where the client device and server work together to perform a given step. Note that while the logic of FIG. 3 is shown in flow chart format, other suitable logic may also be used.

Beginning at block 300, the apparatus may access image data, motion data, and audio data. For example, the apparatus may access the data as loaded into memory, or receive the different types of data directly from the respective sensors themselves. The logic may then proceed to block 310.

At block 310 the apparatus may provide the sensor data to an ML model, such as the example ML model 200 of FIG. 2. The logic may then proceed to block 320 where the apparatus may execute the ML model to process the sensor input and, at block 330, receive an output from the ML model in response that indicates a player input to a computer game.

From block 330 the logic may then proceed to block 340 where the apparatus may provide the output from the ML model to the computer game. If desired, the logic may then proceed to block 350 where the apparatus may execute the computer game consistent with the player input.

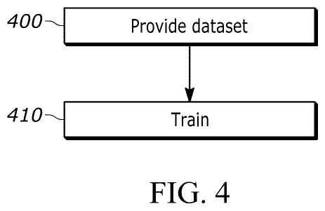

Now in reference to FIG. 4, example logic is shown that may be executed by an apparatus to train an ML model consistent with present principles. Accordingly, at block 400 a training dataset may be provided to then train the ML model at block 410. Various machine-learning techniques may be used, including clustering, supervised learning, self-supervised learning, unsupervised learning, and other deep learning techniques. The dataset that is provided may include, in one example, respective pairings of image/video data, audio data, and IMU data along with a respective ground truth label for a corresponding game command that embodies the player's intent indicated in the raw sensor data itself.

Moving on from FIG. 4, it is to be understood that sensor-side or host-side encoding may be executed consistent with present principles. Encoding can happen directly on the sensor, where raw data is pre-processed and compressed into a high-level format. This encoding system, either built into the sensor hardware or connected to it, may capture key features from each sensor type (IMU, video, audio) and transform them into a shared latent space. This shared space creates consistent, interpretable representations across different sensors, allowing the game engine to easily understand each input. These compact latent vectors may be transmitted from each sensor. Because these vectors are compressed, they use significantly less bandwidth than raw data, making them ideal for low-latency, high-efficiency data transmission

In terms of processing, after receiving the latent vectors from various sensors, the game engine may interpret and reason about this compressed data. The game engine can therefore receive latent vectors from multiple sensors, such as IMU for body movement, cameras for objects and gestures, eye-tracking for gaze direction, and audio for speech. Neural networks and algorithms may then analyze these combined inputs to determine specific player intentions with surroundings.

Based on the interpretation of these latent vectors, the game engine can then make real-time adjustments in gameplay, reducing latency and enhancing responsiveness. The system's multi-sensor decoder may combine data from each input, creating a comprehensive view of the player's state and surroundings. This approach minimizes data processing needs and boosts responsiveness, especially for resource-heavy, real-time gaming like VR, AR, or cloud gaming, where bandwidth is a key factor.

While the particular embodiments are herein shown and described in detail, it is to be understood that the subject matter which is encompassed by the present application is limited only by the claims.

What is claimed is:

1. An apparatus, comprising:
at least one processor system configured to:
access image data, motion data, and audio data;
provide the image data, the motion data, and the audio data to a machine learning (ML) model as input;
receive, from the ML model in response to the input, an output indicating a player input to a computer game; and
in response to receiving the output, provide the player input to the computer game.

2. The apparatus of claim 1, wherein the at least one processor system is configured to:
execute the computer game consistent with the player input.

3. The apparatus of claim 1, wherein the image data is received from a camera, and wherein the image data comprises video.

4. The apparatus of claim 1, wherein the motion data is received from an inertial measurement unit (IMU).

5. The apparatus of claim 4, wherein the IMU comprises one or more of: an accelerometer, a gyroscope, a magnetometer.

6. The apparatus of claim 1, wherein the audio data is received from a microphone.

7. The apparatus of claim 1, wherein the ML model comprises a latent vector model.

8. The apparatus of claim 7, wherein the ML model comprises a player-based encoder.

9. A method, comprising:
accessing image data, motion data, and audio data;
providing the image data, the motion data, and the audio data to a machine learning (ML) model as input;
receiving, from the ML model in response to the input, an output indicating a player input to a computer game; and
in response to receiving the output, providing the player input to the computer game.

10. The method of claim 9, comprising:
executing the computer game consistent with the player input.

11. The method of claim 9, wherein the image data is received from a camera, the motion data is received from an inertial measurement unit (IMU), and the audio data is received from a microphone.

12. The method of claim 9, wherein the ML model comprises a latent vector model.

13. The method of claim 12, wherein the ML model comprises a player-based encoder.

14. An apparatus, comprising:
at least one computer readable storage medium (CRSM) that is not a transitory signal, the at least one CRSM comprising instructions executable by a processor system to:
access image data, motion data, and audio data;
provide the image data, the motion data, and the audio data to a machine learning (ML) model as input;
receive, from the ML model in response to the input, an output indicating a player input to a computer game; and
in response to receiving the output, provide the player input to the computer game.

15. The apparatus of claim 14, wherein the instructions are executable to:
execute the computer game consistent with the player input.

16. The apparatus of claim 14, wherein the image data is received from a camera.

17. The apparatus of claim 14, wherein the motion data is received from one or more of: an accelerometer, a gyroscope, a magnetometer.

18. The apparatus of claim 14, wherein the audio data is received from a microphone.

19. The apparatus of claim 14, wherein the ML model comprises a latent vector model.

20. The apparatus of claim 19, wherein the ML model comprises a player-based encoder.
